(19) United States
(12) Patent Application Publication
(10) Pub. No.: US 2026/0084458 A1
(43) Pub. Date: Mar. 26, 2026

(54) Pencil Clamping Mechanism for Pencil Sharpener

(71) Applicant: DELI GROUP CO. LTD, Ningbo, Zhejiang (CN)

(72) Inventor: Chengjun PAN, Ningbo, Zhejiang (CN)

(73) Assignee: DELI GROUP CO. LTD, Ningbo, Zhejiang (CN)

(21) Appl. No.: 19/110,977

(22) PCT Filed: Dec. 13, 2023
(86) PCT No.: PCT/CN2023/138572

§ 371 Date: Mar. 12, 2025

(30) Foreign Application Priority Data
Oct. 27, 2022 (CN) 202211328292.2
Jul. 21, 2023 (CN) 202310898710.X

(51) Int. Cl. B43L 23/00

(52) U.S. Cl. CPC B43L 23/002

(57) ABSTRACT

A pencil clamping mechanism for a pencil sharpener includes a support, at least two pencil clamping roller assemblies are disposed on the support, and a pencil clamping area for a pencil to be inserted in is formed between the pencil clamping roller assemblies; one end of the pencil clamping roller assembly is rotatably connected on the support, and the other end of the pencil clamping roller assembly is connected on the support in a sliding mode; a ball head is disposed at one end of the pencil clamping roller assembly, an embedding groove matched with the ball head is disposed on the support, and the ball head is rotatably connected in the embedding groove.

### CROSS-REFERENCE TO RELATED APPLICATIONS

This application claims priority to Chinese patent application No. 202211328292.2 filed on Oct. 27, 2022 and entitled “Pencil Clamping Mechanism for Pencil Sharpener”.

This application claims priority to Chinese patent application No. 202310898710.X filed on Jul. 21, 2023 and entitled “Pencil Clamping Mechanism for Pencil Sharpener”.

### Technical Field

The disclosure relates to the technical field of stationery, and in particular to a pencil clamping mechanism for a pencil sharpener.

### BACKGROUND

As a pencil sharpening tool, a pencil sharpener is popular among students. The pencil sharpener includes a pencil feeding mechanism and a pencil sharpening mechanism, when pencil sharpening is carried out, a pencil passes through the pencil feeding mechanism and enters the pencil sharpening mechanism, the pencil is clamped by the pencil feeding mechanism after the pencil is fed in place, and then the pencil sharpening mechanism sharpens a pencil point. After pencil sharpening is finished, the pencil feeding mechanism may also withdraw the pencil out of the pencil sharpener.

Patent No. CN215474153U discloses a three-wheel pencil feeding device for a pencil sharpener. The pencil feeding device includes a support, as well as a rotary disc and clamping wheel assemblies which are movably mounted on the support, and a pencil feeding hole for a pencil holder to pass through is disposed in a middle of the rotary disc. Three groups of clamping wheel assembly are available, the three groups of clamping wheel assemblies are disposed in an equilateral triangle mode by taking the pencil feeding hole as a center, a stress is uniform in a sharpening process of the pencil sharpener, the stability is good, a lead breaking phenomenon may be effectively reduced, meanwhile, a rubber wheel is little in abrasion and normal in slipping, and a service life of a product is prolonged. However, the clamping wheel assemblies of the pencil feeding device are fixed, so as not to be suitable for pencils with different shapes and different pencil diameters, and a universality of the pencil feeding device is poor. In order to solve the problem, an end of the clamping wheel assemblies of the pencil feeding mechanism of the pencil sharpener is made into a movable structure, when pencils with different shapes and different pencil diameters are inserted, the end of the clamping wheel assemblies may be extruded to move, and a moving end of the clamping wheel assemblies is supported by an elastic piece, so that the clamping wheel assemblies may clamp the pencil all the time. At present, the clamping wheel assemblies of the pencil sharpener have some problems, an end of the clamping wheel assemblies in the relevant art is rotatably connected to the support, namely, an installation shaft hole is disposed in the support, and one end of a central shaft of the clamping wheel assemblies is rotatably connected in the installation shaft hole; and the other end of the clamping wheel assemblies is connected to the support in a sliding mode. The other end of the clamping wheel assemblies is rotatably connected in the installation shaft hole, due to limiting of the installation shaft hole, sliding of the other end of the clamping wheel assemblies is affected, so that the clamping wheel assemblies is not flexible enough in sliding, and the flexibility of adjusting the pencil feeding hole among the three groups of clamping wheel assembly is influenced.

### SUMMARY

The technical problem to be solved by the disclosure is to provide a pencil clamping mechanism for a pencil sharpener, which may be suitable for pencils with different shapes and different pencil diameters, the universality of pencil feeding is good, meanwhile, the movement of a pencil clamping roller assembly is flexible, and a size of a pencil feeding hole may be flexibly adjusted.

The technical solution of the disclosure is: a pencil clamping mechanism for a pencil sharpener with the following structure is provided, which includes a support, at least two pencil clamping roller assemblies are disposed on the support, and a pencil clamping area for a pencil to be inserted in is formed between the pencil clamping roller assemblies; one end of each of the pencil clamping roller assemblies is rotatably connected with the support, and the other end of each of the pencil clamping roller assemblies is slidably connected with the support; and a ball head is disposed at an end of each of the pencil clamping roller assemblies, an embedding groove matched with the ball head is disposed on the support, and the ball head is rotatably connected within the embedding groove.

With the adoption of the above structure, the pencil clamping mechanism for a pencil sharpener of the disclosure, compared with the relevant art, has the following advantages.

For the pencil clamping mechanism for a pencil sharpener of the disclosure, one end of each of the pencil clamping roller assemblies is rotatably connected with the support, the other end of each of the pencil clamping roller assemblies is connected with the support in a sliding mode, then when pencils of different shapes and different sizes are inserted into a triangular pencil clamping area, the other end of the pencil clamping roller assemblies may be adjusted in position. The ball head is disposed at the one end of each of the pencil clamping roller assemblies, the embedding groove matched with the ball head is disposed on the support, the ball head is rotatably connected in the embedding groove, the end of each of the pencil clamping roller assemblies is flexibly connected with the support, the pencil clamping roller assemblies may move in multiple directions, and the size of the pencil feeding hole may be flexibly adjusted.

In an embodiment, a clamping assembly is disposed between the other end of each of the pencil clamping roller assemblies and the support, the clamping assembly includes a clamping piece and a return elastic piece, the clamping piece is movably connected with the support and abuts against the other end of each of the pencil clamping roller assemblies, the return elastic piece is supported between the clamping piece and the support, and the clamping piece is connected with the return elastic piece. With adoption of the structure, when the other end of each of the pencil clamping roller assemblies moves outwards, the clamping piece applies an elastic thrust to the other end of each of the pencil clamping roller assemblies, so that each of the pencil clamping roller assemblies always contacts the pencil, each clamping piece is connected with the same return elastic piece, so that synchronization of movement of each of the pencil clamping roller assemblies may be guaranteed, and eccentricity of the movement of each of the pencil clamping roller assemblies seldom occurs.

In an embodiment, a first support wall and a second support wall are disposed on the support, and each of the pencil clamping roller assemblies is disposed between the first support wall and the second support wall; each of the pencil clamping roller assemblies includes a rotating shaft, a ball head is disposed at one end of the rotating shaft, and an embedding groove is disposed on the first support wall; and a sliding groove is disposed on the second support wall, and the other end of the rotating shaft is slidably fitted in the sliding groove in a sliding mode. With adoption of the structure, the pencil clamping roller assembly is simple in assembly structure and convenient to assemble.

In an embodiment, an accommodating cavity is disposed on the second support wall, and the accommodating cavity communicates with the sliding groove; the clamping piece is movably installed in the accommodating cavity, one side of the clamping piece abuts against the other end of the rotating shaft, and the other end of the rotating shaft slides to push the clamping piece to move towards outside. With adoption of the structure, the clamping piece is simple in assembly structure and convenient to assemble, and the accommodating cavity may limit movement range of the clamping piece, so that the movement of the clamping piece is more stable.

In an embodiment, one end of the clamping piece is hinged on a side wall of the accommodating cavity, one side of a middle of the clamping piece abuts against the other end of the rotating shaft, and the other end of the clamping piece is connected with the return elastic piece. With adoption of the structure, the middle of the clamping piece abuts against the other end of the rotating shaft, so that a contact area between the clamping piece and the rotating shaft is larger, and the clamping effect is better.

In an embodiment, the side of the middle of the clamping piece is an arc surface, and the arc surface abuts against the other end of the rotating shaft. With adoption of the structure, the arc surface of the clamping piece contacts the other end of the rotating shaft, and setting of radian of the arc surface may effectively control the clamping force of the clamping piece, so that the clamping effect is better.

In an embodiment, a roller of each of the pencil clamping roller assemblies is installed on the rotating shaft, and a gear is further installed on the rotating shaft; the gear is connected with a driving device, the driving device drives the gear to rotate, and the gear may drive the rotating shaft and the roller to rotate synchronously. With adoption of the structure, the rotating shaft and the roller are driven by the gear to rotate, the structure is simple, and the driving effect is good.

In an embodiment, a third support wall is disposed on the support and located between the first support wall and the second support wall, and the third support wall is supported by a lower side of a portion, located between the gear and the roller, of the rotating shaft. With adoption of the structure, due to effect of the third support wall, the installation of the rotating shaft is more stable. In an embodiment, a first groove is formed in an upper surface of the third support wall, and the rotating shaft is embedded in the first groove. With adoption of the structure, the installation of the rotating shaft is more reliable.

In an embodiment, a shaft sleeve is connected with a side of the gear, a shaft hole is formed in a middle of the gear, and the shaft hole and a through hole of the shaft sleeve are coaxial and mutually communicated; at least one limiting plane is disposed on a side wall of the rotating shaft, and a shape of the shaft hole of the gear and a shape of the through hole of the shaft sleeve are matched with a cross section of the rotating shaft; the gear and the shaft sleeve sleeve outside the rotating shaft, and an end of the shaft sleeve abuts against the roller; and the shaft sleeve is embedded in the first groove. With adoption of the structure, the structure is simple, and the assembly is convenient.

In an embodiment, an installation hole is formed in a middle of the roller, a connecting sleeve is disposed in the installation hole, a shape of a through hole of the connecting sleeve is matched with a shape of the cross section of the rotating shaft, and the connecting sleeve is tightly fitted outside the rotating shaft and the connecting sleeve abuts against an outer side of the shaft sleeve. With adoption of the structure, the roller is simple in installation structure and convenient to assemble.

In an embodiment, a limiting sheet is disposed on the rotating shaft and on the outer side of the gear, and the limiting sheet is limited on an outer side of the gear. With adoption of the structure, the limiting sheet has a limiting effect on the gear.

In an embodiment, a convex column is disposed at an end part, close to the roller, of the rotating shaft, a cross section of the convex column is round, and the convex column is rollably installed at a bottom of the sliding groove. With adoption of the structure, the convex column may flexibly rotate at the bottom of the sliding groove.

In an embodiment, a limiting ring for the pencil to be inserted in is disposed in a middle of the support, the limiting ring is connected with the second support wall and the third support wall, the limiting ring is erected directly above the triangular pencil clamping area, and an orthographic projection of the limiting ring covers a part of the roller. With adoption of the structure, the limiting ring may locate the pencil, so that pencil sharpening is more stable.

In an embodiment, the return elastic piece is an elastic hoop, and the elastic hoop sleeves outside the other end of the clamping piece; a synchronization piece is rotatably connected with the support, one end of the elastic hoop is connected with the support, the other end of the elastic hoop is connected with the synchronization piece; and the elastic hoop may drive the synchronization piece to rotate when extruded by the clamping piece to twist. With adoption of the structure, the elastic hoop is outside the other end of the clamping piece, so that synchronization of movement of each clamping piece may be guaranteed, and eccentricity of the movement of the pencil clamping roller assembly seldom occurs.

In an embodiment, the synchronization piece is disposed on an upper side of the clamping piece, and a sliding track is disposed at a position, corresponding to the clamping piece, of the synchronization piece; a lower end of the clamping piece is hinged on the support, and the upper end of the clamping piece is slidably fitted within the sliding track; and a rotation of the synchronization piece may drive the clamping piece to rotate, and meanwhile, the upper end of the clamping piece slides along the sliding track. With adoption of the structure, when pencils of different shapes and different sizes are inserted into the triangular pencil clamping area, the movable end of the pencil clamping roller assemblies may move due to squeezing, further, the clamping piece is pushed to rotate, the elastic hoop may twist after being stressed, thus driving the synchronization piece to rotate. The rotation of the synchronization piece also drives the upper end of the clamping piece to slide along the sliding track, so that the upper end of the clamping piece may be opened and closed with the lower end as a center of a circle at the same time, thus the pencil is always in the middle of the three pencil clamping roller assemblies during pencil sharpening, pencil sharpening is more stable, and eccentricity is avoided.

In an embodiment, a sliding direction of the sliding track is intersected with a swing direction of the clamping piece. With adoption of the structure, the rotation of the synchronization piece cannot affect rotation of the clamping piece, the matching effect is good.

In an embodiment, the support includes an upper cover, which is connected with a side, close to the synchronization piece, of the support; the synchronization piece is rotatably connected with an upper side of the upper cover; the elastic hoop is disposed between the upper cover and the synchronization piece, and the one end of the elastic hoop is connected on the upper cover. With adoption of the structure, the upper cover is disposed, so that the internal structure may be protected, and the structure is more reliable.

In an embodiment, a first pencil inserting hole is formed at a position, above the triangular pencil clamping area, of the upper cover, and an orthographic projection of the first pencil inserting hole covers part of each of the roller of the pencil clamping roller assemblies; and a matching hole is formed in the upper cover, and the other end of the clamping piece passes through the matching hole to be matched in the sliding track. With adoption of the structure, the structure is simple and reliable, and the assembly is convenient.

In an embodiment, a plurality of locating columns are disposed on a side, close to the synchronization piece, of the upper cover; rotating track holes matched with the locating columns are disposed on the synchronization piece, and end parts of the locating columns are fitted in the rotating track holes; and when the synchronization piece is driven by the elastic hoop to rotate, the locating columns slide relative to the rotating track holes. With adoption of the structure, the locating columns may limit a movement track of the synchronization piece, so that the synchronization piece may accurately drive the clamping piece, and the effect that the clamping piece rotates synchronously is achieved.

In an embodiment, a second pencil inserting hole is formed in a middle of the synchronization piece, and the second pencil inserting hole aligns with the first pencil inserting hole; and an inserting hole is formed in the synchronization piece, an end part of the elastic hoop is upwards folded to form an inserting pin, and the inserting pin is inserted in the inserting hole. With adoption of the structure, the locating effect for the pencil is good, and assembly between the elastic hoop and the

In an embodiment, a bolt column is further disposed on the side, close to the synchronization piece, of the upper cover, a ring is disposed at an end part of the elastic hoop, and the ring sleeves outside the bolt column. With adoption of the structure, the assembly between the upper cover and the elastic hoop is simple in structure and convenient.

In an embodiment, three groups of pencil clamping roller assemblies are available, and a triangular pencil clamping area is formed among the three groups of pencil clamping roller assemblies. With adoption of the structure, the three groups of pencil clamping roller assemblies are stable in structure, pencil clamping is more reliable, eccentricity seldom occurs, and the size of the triangular pencil clamping area is more flexible to adjust.

### BRIEF DESCRIPTION OF THE DRAWINGS

FIG. 1 is a schematic structure diagram of a three-dimensional view of a pencil clamping mechanism for a pencil sharpener of the disclosure.

FIG. 2 is a schematic structure diagram of an exploded view of a pencil clamping mechanism for a pencil sharpener of the disclosure.

FIG. 3 is a partial schematic diagram of an exploded view of a pencil clamping mechanism for a pencil sharpener of the disclosure.

FIG. 4 is a schematic diagram of an assembly structure of a pencil clamping roller assembly and a support of a pencil clamping mechanism for a pencil sharpener of the disclosure.

FIG. 5 is a schematic diagram of an assembly structure at another angle of a pencil clamping roller assembly and a support of a pencil clamping mechanism for a pencil sharpener of the disclosure.

FIG. 6 is a schematic structure diagram of an exploded view of a pencil clamping roller assembly and a support of a pencil clamping mechanism for a pen sharpener of the disclosure.

FIG. 7 is a schematic structure diagram of an exploded view of a pencil clamping roller assembly of a pencil clamping mechanism for a pen sharpener of the disclosure.

In the drawings: 1. Support; 101. First support wall; 102. Second support wall; 103. Third support wall; 104. Embedding groove; 105. First groove; 106. Sliding groove; 107. Limiting ring; 108. Accommodating cavity; 2. Upper cover; 201. First pencil inserting hole; 202. Matching hole; 203. Bolt column; 204. Locating column; 3. Synchronization piece; 301. Second pencil inserting hole; 302. Sliding track; 303. Inserting hole; 304. Rotating track hole; 4. Triangular pencil clamping area; 5. Rotating shaft; 501. Limiting plane; 502. Ball head; 503. Convex column; 6. Roller; 7. Gear; 701. Shaft sleeve; 8. Limiting sheet; 9. Connecting sleeve; 901. Embedding ring; 10. Clamping piece; 1001. Arc surface; 11. Elastic hoop; 1101. Inserting pin; and 1102. Ring.

### DETAILED DESCRIPTION OF THE EMBODIMENTS

For a better understanding of the disclosure, a more detailed explanation of all aspects of the disclosure will be provided with reference to the attached drawings. It should be understood that the detailed descriptions are only descriptions of exemplary implementation modes of the disclosure and are not intended to limit the protection scope of the disclosure in any way. Throughout the specification, same reference signs refer to same components.

In the drawings, the thickness, size and shape of the object have been slightly exaggerated for ease of illustration. The drawings are examples only and are not drawn strictly to scale.

It should be further understood that the terms “include”, “comprise” or “have”, “contain”, “containing” or the like, used in the specification, specify the presence of stated features, integers, steps, operations, components and/or parts, but do not preclude the presence or addition of one or more other features, integers, steps, operations, components, parts, and/or a combination thereof.

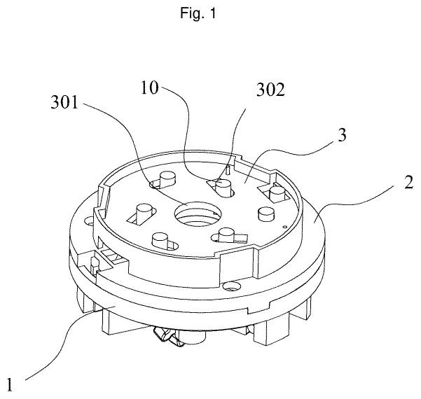

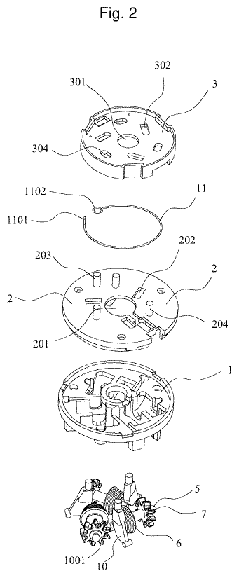

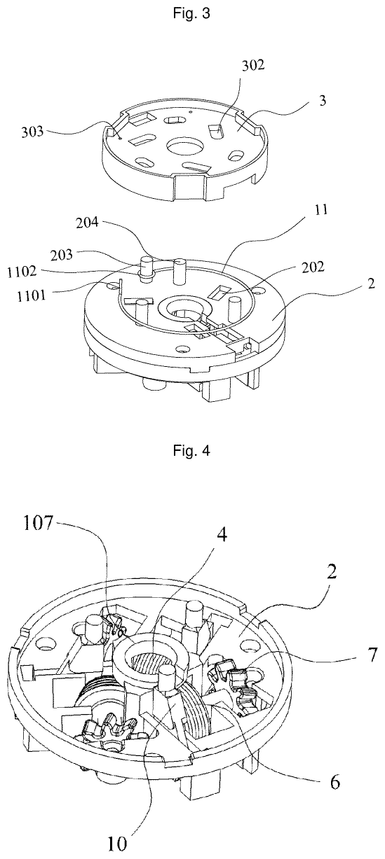

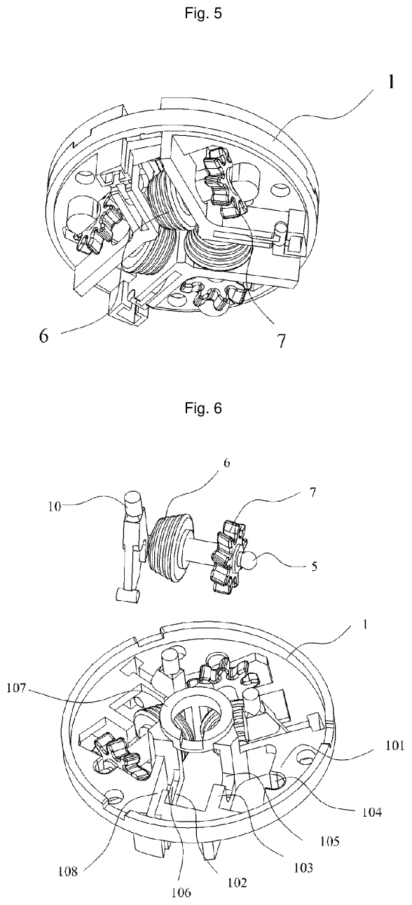

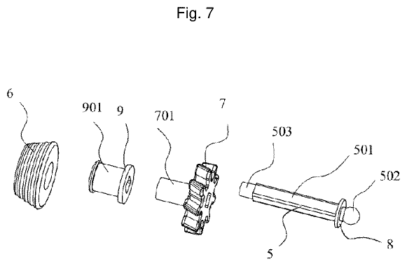

As shown in FIGS. 1-7, the disclosure provides a pencil clamping mechanism for a pen sharpener, which includes a support 1, an upper cover 2 and a synchronization piece 3. Three pencil clamping roller assemblies are disposed on the support 1, the structure and installation structure of the three pencil clamping roller assemblies are the same, and a triangular pencil clamping area 4 is formed among the three pencil clamping roller assemblies.

The pencil clamping roller assembly includes a rotating shaft 5, a roller 6 and a gear 7. At least one limiting plane 501 is disposed on a side wall of the rotating shaft 5, in the specific embodiment, a cross section of the rotating shaft 5 is square. A limiting sheet 8 is disposed on the side wall of an end of the rotating shaft 5, and the limiting sheet 8 is round. A shaft sleeve 701 is connected with a side of the gear 7, the shaft sleeve 701 and the gear 7 are integrally formed, a shaft hole is formed in a middle of the gear 7, and the shaft hole and a through hole of the shaft sleeve 701 are coaxial and mutually communicated. A shape of the shaft hole and a shape of the through hole of the shaft sleeve 701 are matched with a shape of the rotating shaft 5. The gear 7 and the shaft sleeve 701 sleeve outside the rotating shaft 5, and an end surface of the gear 7 abuts against the limiting sheet 8. An installation hole is formed in a middle of the roller 6, a connecting sleeve 9 is disposed in the installation hole, an embedding ring 901 is disposed on a peripheral wall of the connecting sleeve 9, the roller 6 is made of a rubber material, and an inner ring of the roller 6 is embedded in the embedding ring 901. A shape of a through hole of the connecting sleeve 9 is matched with a shape of the rotating shaft 5, the connecting sleeve 9 sleeves outside the rotating shaft 5 and the connecting sleeve 9 is tightly fitted with the rotating shaft 5, and an end of the connecting sleeve 9 abuts against an end face of the shaft sleeve 701.

In an embodiment, a pencil clamping mechanism includes a support 1, at least two pencil clamping roller assemblies are disposed on the support 1, and a pencil clamping area 4 for a pencil to be inserted in is formed between the pencil clamping roller assemblies; one end of each of the pencil clamping roller assemblies is rotatably connected with the support 1, and the other end of each of the pencil clamping roller assemblies is connected with the support 1 in a sliding mode; and a ball head is disposed at the one end of each of the pencil clamping roller assemblies, an embedding groove matched with the ball head is disposed on the support, and the ball head is rotatably connected within the embedding groove.

With the adoption of the above structure, the pencil clamping mechanism for a pencil sharpener of the disclosure, compared with the relevant art, has the following advantages.

For the pencil clamping mechanism for a pencil sharpener of the disclosure, one end of each of the pencil clamping roller assemblies is rotatably connected with the support, the other end of each of the pencil clamping roller assemblies is connected with the support 1 in a sliding mode, then when pencils of different shapes and different sizes are inserted into a triangular pencil clamping area, the other end of each of the pencil clamping roller assemblies may be adjusted in position. A ball head 502 is disposed at the one end of each of the pencil clamping roller assemblies, an embedding groove 104 matched with the ball head 502 is disposed on the support 1, the ball head 502 is rotatably connected within the embedding groove 104, the one end of each of the pencil clamping roller assemblies is flexibly connected with the support 1, the pencil clamping roller assembly may move in multiple directions, and the size of the pencil feeding hole may be flexibly adjusted.

In an embodiment, a clamping assembly is disposed between the other end of each of the pencil clamping roller assemblies and the support 1, the clamping assembly includes a clamping piece 10 and a return elastic piece, the clamping piece 10 is movably connected with the support 1 and the clamping piece 10 abuts against the other end of each of the pencil clamping roller assemblies, the return elastic piece is supported between the clamping piece 10 and the support 1, and the clamping piece 10 is connected with the return elastic piece. With adoption of the structure, when the other end of each of the pencil clamping roller assemblies moves outwards, the clamping piece 10 applies an elastic thrust to the other end of each of the pencil clamping roller assemblies, so that the pencil clamping roller assembly always contacts the pencil, each clamping piece 10 is connected with the same return elastic piece, so that synchronization of movement of each of the pencil clamping roller assemblies may be guaranteed, and eccentricity of the movement of each of the pencil clamping roller assemblies seldom occurs.

In an embodiment, a first support wall 101 and a second support wall 102 are disposed on the support, and each of the pencil clamping roller assemblies is disposed between the first support wall 101 and the second support wall 102; each of the pencil clamping roller assemblies includes a rotating shaft 5, a ball head 502 is disposed at one end of the rotating shaft 5, and an embedding groove 104 is disposed on the first support wall 101; and a sliding groove 106 is disposed on the second support wall 102, and the other end of the rotating shaft 5 is fitted in the sliding groove 106 in a sliding mode. With adoption of the structure, the pencil clamping roller assembly is simple in assembly structure and convenient to assemble.

In an embodiment, a third support wall 103 located between the first support wall 101 and the second support wall 102 is disposed on the support 1. A ball head 502 is disposed at an end part, close to the gear 7, of the rotating shaft 5, and the ball head 502 is disposed on an outer side of the limiting sheet 8. An embedding groove 104 matched with the ball head 502 is disposed on a side wall of the first support wall 101, and the ball head 502 is rotatably connected within the embedding groove 104. The third support wall 103 is disposed on a lower side of the shaft sleeve 701 on the rotating shaft 5, a first groove 105 is formed in an upper end face of the third support wall 103, and the shaft sleeve 701 is embedded in the first groove 105. A sliding groove 106 is disposed on the second support wall 102, a convex column 503 is disposed at an end part, close to the roller 6, of the rotating shaft 5, a cross section of the convex column 503 is round, the convex column 503 is installed at a bottom of the sliding groove 106 in a rolling mode, and when the rotating shaft 5 is stressed, the convex column 503 may slide back and forth along the bottom of the sliding groove 106. With adoption of the structure, the convex column 503 may flexibly rotate at the bottom of the sliding groove 106. Each pencil clamping roller assembly on the support 1 are installed by the first support wall 101, the second support wall 102 and the third support wall 103, and the installation structures are the same. A limiting ring 107 for the pencil to be inserted in is disposed in a middle of the support 1, the limiting ring 107 is connected with all the second support walls 102 and the third support walls 103 on the support 1, the limiting ring 107 is erected directly above the triangular pencil clamping area 4, and an orthographic projection of the limiting ring 107 covers a part of the roller 6.

With adoption of the structure, due to effect of the third support wall 103, the installation of the rotating shaft 5 is more

In an embodiment, a clamping assembly is disposed at a position, close to the convex column 503, of the support 1, and the clamping assembly includes a clamping piece 10 and a return elastic piece. An accommodating cavity 108 is disposed on the second support wall 102, an upper end and a lower end of the accommodating cavity 108 are open, the accommodating cavity 108 communicates with the sliding groove 106, and an end part of the convex column 503 extends into the accommodating cavity 108. A lower end of the clamping piece 10 is hinged on a side wall of the accommodating cavity 108, and a side of a middle of the clamping piece 10 abuts against the convex column 503. An arc surface 1001 is disposed on a side, close to the convex column 503, of the middle of the clamping piece 10, the arc surface 1001 abuts against an outer wall of the convex column 503, and a convex ring slides outwards to push the clamping piece 10 to rotate around a joint of the lower end of the clamping piece 10.

With adoption of the structure, the clamping piece is simple in assembly structure and convenient to assemble, and the accommodating cavity 108 may limit a movement range of the clamping piece, so that the movement of the clamping piece is more stable.

In an embodiment, one end of the clamping piece 1 is hinged on the side wall of the accommodating cavity 108, one side of the middle of the clamping piece 1 abuts against the other end of the rotating shaft 5, and the other end of the clamping piece 10 is connected with the return elastic piece. With adoption of the structure, the middle of the clamping piece abuts against the other end of the rotating shaft 5, so that a contact area between the clamping piece 10 and the rotating shaft 5 is larger, and the clamping effect is better.

In an embodiment, the one side of the middle of the clamping piece 10 is an arc surface 1001, and the arc surface 1001 abuts against the other end of the rotating shaft. With adoption of the structure, the arc surface of the clamping piece contacts the other end of the rotating shaft 5, and setting of radian of the arc surface 1001 may effectively control the clamping force of the clamping piece 10, so that the clamping effect is better.

The upper cover 2 is connected on the upper side of the support 1, and the upper cover 2 may cover the clamping roller assembly. A first pencil inserting hole 201 is formed in the middle of the upper cover 2, the first pencil inserting hole 201 is located directly above the triangular pencil clamping area 4, and the orthographic projection of the first pencil inserting hole 201 covers part of the roller 6 of each of the pencil clamping roller assemblies. A first matching hole 202 is formed in the upper cover 2, and the upper end of the clamping piece 10 passes through the first matching hole 202 to be exposed of the upper cover 2, and the clamping piece 10 may move in the first matching hole 202. With adoption of the structure, the structure is simple and reliable, and the assembly is convenient. The return elastic piece is an elastic hoop 11, and the elastic hoop 11 hoops outside the other end of the clamping piece 10.

With adoption of the structure, the elastic hoop 11 is outside the other end of the clamping piece 10, so that synchronization of movement of the clamping piece may be guaranteed, and eccentricity the movement of each of the pencil clamping roller assemblies seldom occurs.

The synchronization piece 3 is disposed on the upper cover 2, a second pencil inserting hole 301 is formed in a middle of the synchronization piece 3, and the second pencil inserting hole 301 aligns with the first pencil inserting hole 201. A sliding track 302 is disposed on the synchronization piece 3, the other end of the clamping piece 10 extends into the sliding track 302, and the clamping piece 10 is slidably fitted within the sliding track 302; and in the specific embodiment, the sliding track 302 is of a hole-shaped structure. The elastic hoop 11 is disposed in a space between the synchronization piece 3 and the upper cover 2. One end of the elastic hoop 11 is connected with the synchronization piece 3, namely, an inserting hole 303 is formed in the synchronization piece 3, one end of the elastic hoop 11 is upwards folded to form an inserting pin 1101, and the inserting pin 1101 is inserted in the inserting hole 303. The other end of the elastic hoop 11 is connected with the upper cover 2, a bolt column 203 is disposed on the upper cover 2, a ring 1102 is disposed at the other end of the elastic hoop 11, and the ring 1102 sleeves outside the bolt column 203.

A plurality of locating columns 204 are disposed on the side, close to the synchronization piece 3, of the upper cover 2, rotating track holes 304 matched with the locating columns 204 are disposed on the synchronization piece 3, and end parts of the locating columns 204 are fitted in the rotating track holes 304; and when the synchronization piece 3 is driven by the elastic hoop 11 to rotate, the locating columns 204 slide relative to the rotating track holes 304. The locating column 204 is located on an inner side of the elastic hoop 11. With adoption of the structure, the locating columns may limit a movement track of the synchronization piece, so that the synchronization piece may accurately drive the clamping piece, and the effect that the clamping piece rotates synchronously is achieved.

In an embodiment, the synchronization piece 3 is disposed on an upper side of the clamping piece 10, and a sliding track 302 is disposed at a position, corresponding to the clamping piece 10, of the synchronization piece 3; a lower end of the clamping piece 10 is hinged on the support, and the upper end of the clamping piece 10 is slidably fitted within the sliding track 302; and a rotation of the synchronization piece 3 may drive the clamping piece 10 to rotate, and meanwhile, the upper end of the clamping piece 10 slides along the sliding track 302. With adoption of the structure, when pencils of different shapes and different sizes are inserted into the triangular pencil clamping area, the movable end of each of the pencil clamping roller assemblies may move due to squeezing, further, the clamping piece 10 is pushed to rotate, the elastic hoop 11 may twist after being stressed, thus driving the synchronization piece 3 to rotate. The rotation of the synchronization piece 3 also drives the upper end of the clamping piece 10 to slide along the sliding track 302, so that the upper end of the clamping piece 10 may be opened and closed with the lower end as a center of a circle at the same time, thus the pencil is always in the middle of the three pencil clamping roller assemblies during pencil sharpening, pencil sharpening is more stable, and eccentricity is avoided.

In an embodiment, a sliding direction of the sliding track 302 is intersected with a swing direction of the clamping piece 10. With adoption of the structure, the rotation of the synchronization piece 3 cannot affect rotation of the clamping piece 10, the matching effect is good.

When the pencil clamping mechanism for a pencil sharpener of the disclosure works, pencils of different pencil diameters or different shapes enter the triangular pencil clamping area 4 after passing through the second pencil inserting hole 301 and the first pencil inserting hole 201 in sequence. The rotating shaft 5 is extruded by the pencil, and the convex column 503 at the end part of the rotating shaft 5 slides in the sliding groove 106. The convex column 503 slides to push the clamping piece 10 to rotate, the clamping piece 10 rotates to enable the elastic hoop 11 to deform so as to drive the synchronization piece 3 to rotate, the synchronization piece 3 rotates to drive the clamping piece 10 to rotate synchronously, thus realizing synchronous opening of the clamping piece 10, and the roller 6 is adjusted to an appropriate position. The pencil is driven by the roller 6 to be rolled into the pencil feeding mechanism. When the pencil is withdrawn from the pencil feeding mechanism, the pencil does not extrude the roller 6 anymore, the convex column 503 is restored to an initial position under the clamping force of the clamping piece 10, and at the moment, the clamping piece 3 may drive the clamping piece 10 to be synchronously closed.

The disclosure is not limited to the above implementation mode, any person can obtain products of any other forms under the inspiration of the disclosure, but any changes in shape or structure, which have the same or similar technical solution as the disclosure, fall within the protection scope of the disclosure.

1. A pencil clamping mechanism for a pencil sharpener, comprising a support, wherein at least two pencil clamping roller assemblies are disposed on the support and a pencil clamping area for a pencil to be inserted in is formed between the pencil clamping roller assemblies; one end of each of the pencil clamping roller assemblies is rotatably connected with the support, and the other end of each of the pencil clamping roller assemblies is slidably connected with the support; wherein a ball head is disposed at the one end of each of the pencil clamping roller assemblies, an embedding groove matched with the ball head is disposed on the support, and the ball head is rotatably connected within the embedding groove.

2. The pencil clamping mechanism for the pencil sharpener according to claim 1, wherein a clamping assembly is disposed between the other end of each of the pencil clamping roller assemblies and the support, the clamping assembly comprises a clamping piece and a return elastic piece, the clamping piece is movably connected with the support and the clamping piece abuts against the other end of each of the pencil clamping roller assemblies, the return elastic piece is supported between the clamping piece and the support and the clamping piece is connected with the return elastic piece.

3. The pencil clamping mechanism for the pencil sharpener according to claim 2, wherein a first support wall and a second support wall are disposed on the support, and each of the pencil clamping roller assemblies is disposed between the first support wall and the second support wall; each of the pencil clamping roller assemblies comprises a rotating shaft, the ball head is disposed at one end of the rotating shaft, and the embedding groove is disposed on the first support wall; and a sliding groove is disposed on the second support wall, and the other end of the rotating shaft is slidably fitted in the sliding groove

4. The pencil clamping mechanism for the pencil sharpener according to claim 3, wherein an accommodating cavity is disposed on the second support wall and the accommodating cavity communicates with the sliding groove the clamping piece is movably installed in the accommodating cavity, a side of the clamping piece abuts against the other end of the rotating shaft, and the other end of the rotating shaft slides to push the clamping piece to move towards outside.

5. The pencil clamping mechanism for the pencil sharpener according to claim 4, wherein one end of the clamping piece is hinged on a side wall of the accommodating cavity, one side of a middle of the clamping piece abuts against the other end of the rotating shaft, and the other end of the clamping piece is connected with the return elastic piece.

6. The pencil clamping mechanism for the pencil sharpener according to claim 5, wherein the side of the middle of the clamping piece is an arc surface and the arc surface abuts against the other end of the rotating shaft.

7. The pencil clamping mechanism for the pencil sharpener according to claim 6, wherein a roller of each of the pencil clamping roller assemblies is installed on the rotating shaft, and a gear is further installed on the rotating shaft the gear is connected with a driving device, the driving device drives the gear to rotate, and the gear is able to drive the rotating shaft and the roller to rotate synchronously.

8. The pencil clamping mechanism for the pencil sharpener according to claim 7, wherein a third support wall is disposed on the support and located between the first support wall and the second support wall, and the third support wall is supported by a lower side of a portion, located between the gear and the roller, of the rotating shaft.

9. The pencil clamping mechanism for the pencil sharpener according to claim 8, wherein a first groove is formed in an upper surface of the third support wall and the rotating shaft is embedded in the first groove

10. The pencil clamping mechanism for the pencil sharpener according to claim 9, wherein a shaft sleeve is connected with a side of the gear a shaft hole is formed in a middle of the gear, and the shaft hole and a through hole of the shaft sleeve are coaxial and mutually communicated; at least one limiting plane is disposed on a side wall of the rotating shaft, and a shape of the shaft hole of the gear and a shape of the through hole of the shaft sleeve are matched with a cross section of the rotating shaft; the gear and the shaft sleeve sleeve outside the rotating shaft, and an end of the shaft sleeve abuts against the roller and the shaft sleeve is embedded in the first groove.

11. The pencil clamping mechanism for the pencil sharpener according to claim 10, wherein an installation hole is formed in a middle of the roller, a connecting sleeve is disposed in the installation hole, a shape of a through hole of the connecting sleeve is matched with a shape of the cross section of the rotating shaft, and the connecting sleeve is tightly fitted outside the rotating shaft and the connecting sleeve abuts against an outer side of the shaft sleeve or, wherein a limiting sheet is disposed on the rotating shaft and on an outer side of the gear, and the limiting sheet is limited on the outer side of the gear.

12. (canceled)

13. The pencil clamping mechanism for the pencil sharpener according to claim 11, wherein a convex column is disposed at an end part, close to the roller, of the rotating shaft, a cross section of the convex column is round, and the convex column is rollably installed at a bottom of the sliding groove

14. The pencil clamping mechanism for the pencil sharpener according to claim 8, wherein a limiting ring for the pencil to be inserted in is disposed in a middle of the support, the limiting ring is connected with the second support wall and the third support wall, the limiting ring is erected directly above the pencil clamping area and an orthographic projection of the limiting ring covers a part of the roller.

15. The pencil clamping mechanism for the pencil sharpener according to claims wherein the return elastic piece is an elastic hoop and the elastic hoop sleeves outside the other end of the clamping piece a synchronization piece is rotatably connected with the support, one end of the elastic hoop is connected with the support, the other end of the elastic hoop is connected with the synchronization piece and the elastic hoop is able to drive the synchronization piece to rotate when extruded by the clamping piece to twist.

16. The pencil clamping mechanism for the pencil sharpener according to claim 15, wherein the synchronization piece is disposed on an upper side of the clamping piece and a sliding track is disposed at a position, corresponding to the clamping piece of the synchronization piece a lower end of the clamping piece is hinged on the support and the upper end of the clamping piece is slidably fitted within the sliding track; and a rotation of the synchronization piece is able to drive the clamping piece to rotate, and meanwhile, the upper end of the clamping piece slides along the sliding track.

17. The pencil clamping mechanism for the pencil sharpener according to claim 16, wherein a sliding direction of the sliding track is intersected with a swing direction of the clamping piece or, wherein the support comprises an upper cover, the upper cover is connected with a side, close to the synchronization piece, of the support; the synchronization piece is rotatably connected with an upper side of the upper cover; the elastic hoop is disposed between the upper cover and the synchronization piece, and the one end of the elastic hoop is connected with the upper cover.

18. (canceled)

19. The pencil clamping mechanism for the pencil sharpener according to claim 17, wherein a first pencil inserting hole is formed at a position, above the pencil clamping area of the upper cover, and an orthographic projection of the first pencil inserting hole covers a part of the roller of each of the pencil clamping roller assemblies; and a matching hole is formed in the upper cover, and the other end of the clamping piece passes through the matching hole to be matched in the sliding track.

20. The pencil clamping mechanism for the pencil sharpener according to claim 19, wherein a plurality of locating columns are disposed on a side, close to the synchronization piece of the upper cover, rotating track holes matched with the locating columns are disposed on the synchronization piece and end parts of the locating columns are fitted in the rotating track holes; and when the synchronization piece is driven by the elastic hoop to rotate, the locating columns slide relative to the rotating track holes.

21. The pencil clamping mechanism for the pencil sharpener according to claim 20, wherein a second pencil inserting hole is formed in a middle of the synchronization piece and the second pencil inserting hole aligns with the first pencil inserting hole and an inserting hole is formed in the synchronization piece an end part of the elastic hoop is upwards folded to form an inserting pin, and the inserting pin is inserted in the inserting hole; or, wherein a bolt column is further disposed on the side, close to the synchronization piece, of the upper cover, a ring is disposed at an end part of the elastic hoop, and the ring sleeves outside the bolt column.

22. (canceled)

23. The pencil clamping mechanism for the pencil sharpener according to claim 1, wherein three groups of pencil clamping roller assemblies are available, and a triangular pencil clamping area is formed among the three groups of pencil clamping roller assemblies.
